(19) United States
(12) Patent Application Publication
(10) Pub. No.: US 2015/0151805 A1
(43) Pub. Date: Jun. 4, 2015

(54) BRACKET FOR TEMPORARY MOUNTING AND DISPLAY OF A RACING NUMBER ON A BICYCLE

(71) Applicant: Patrick Nardi, Chicago, IL (US)

(72) Inventor: Patrick Nardi, Chicago, IL (US)

(21) Appl. No.: 14/613,838

(22) Filed: Feb. 4, 2015

Related U.S. Application Data
(63) Continuation of application No. 12/174,783, filed on Jul. 17, 2008, now abandoned.

(51) Int. Cl. B62J 11/00

(52) U.S. Cl. CPC B62J 11/00

(57) ABSTRACT

A device and method for temporarily mounting and displaying a flexible tag bearing a racing number onto a bicycle. The device includes (a) a fastener configured and arranged for releasable attachment to a bicycle, (b) an arm having a length and pivotably attached to the fastener for pivoting within a plane parallel to the sagittal plane of a bicycle when the bracket is attached to a bicycle as between a storage position and a display position, and (c) a mechanism for releasably securing a racing number tag to the arm such as (i) a plurality of orifices spaced along the length of the arm, or (ii) a retention clip on the arm.

This application is a continuation of U.S. patent application Ser. No. 12/174,783, filed Jul. 17, 2008, which claims priority to and the benefit of U.S. Provisional Patent Application No. 60/950,285, filed Jul. 17, 2007.

### BACKGROUND

Cyclists entered in a race are typically assigned a race number for the race. The race number is printed onto a bib for attachment to the cyclist's clothing and also on a tag, typically an adhesive label, for attachment to the cyclist's bicycle. Upon completion of the race the race number has no further value and both the bib and tag may be retained as a souvenir or simply discarded.

When the tag is an adhesive label, removal of the tag from the bicycle can be difficult and often leaves an unsightly tacky residue on the bicycle.

Accordingly, a substantial need exists for a device capable of allowing a race number to be temporarily attached to a bicycle without interfering with operation of the bicycle while eliminating the problems encountered with traditional adhesive labels.

### SUMMARY OF THE INVENTION

A first aspect of the invention is a bracket for temporary mounting and displaying of a flexible tag bearing a racing number. A first embodiment of the first aspect of the invention includes (a) a fastener configured and arranged for releasable attachment to a bicycle, (b) an arm having a length and pivotably attached to the fastener for pivoting within a plane parallel to the sagittal plane of a bicycle when the bracket is attached to a bicycle as between a storage position and a display position, and (c) a plurality of orifices spaced along the length of the arm.

A second embodiment of the first aspect of the invention includes (a) a fastener configured and arranged for releasable attachment to a bicycle, (b) an arm having a length and pivotably attached to the fastener for pivoting within a plane parallel to the sagittal plane of a bicycle when the bracket is attached to a bicycle as between a storage position and a display position, and (c) at least one retention clip on the arm configured and arranged to releasably secure a flexible tag bearing a racing number to the arm.

A second aspect of the invention is a method of mounting and displaying a racing number on a bicycle. The method includes the steps of (i) attaching an arm having a longitudinal length to a bicycle with the arm extending lengthwise within the sagittal plane of the bicycle, (ii) pivoting the arm within a plane parallel to the sagittal plane of the bicycle from a storage position into a display position, and (iii) releasably attaching a flexible tag bearing a racing number to the arm whereby an edge of the tag extends along the longitudinal length of the arm.

### BRIEF DESCRIPTION OF THE DRAWINGS

FIG. 1 is a side view of one embodiment of the invention.

FIG. 2 is a perspective view of the invention shown in FIG. 1.

FIG. 3 is a top view of the invention shown in FIG. 1.

FIG. 4 is a top view of a second embodiment of the invention.

FIG. 5 is a side view of the invention shown in FIG. 1 mounted to the seat post of a bicycle with the arm pivoted into the display position and a racing number tag attached to the arm.

FIG. 6 is a side view of the invention shown in FIG. 1 mounted to the top tube of a bicycle with the arm pivoted into the display position and a racing number tag attached to the arm.

FIG. 7 is a side view of the invention shown in FIG. 1 mounted to the head tube of a bicycle with the arm pivoted into the display position and a racing number tag attached to the arm.

FIG. 8 is a side view of the invention shown in FIG. 1 mounted to the down tube of a bicycle with the arm pivoted into the display position and a racing number tag attached to the arm.

FIG. 9 is a side view of the invention shown in FIG. 1 mounted to the seat tube of a bicycle with the arm pivoted into the display position and a racing number tag attached to the arm.

### DETAILED DESCRIPTION OF A PREFERRED EMBODIMENT

### Nomenclature

10 Bracket
20 Fastener
29 Bore
30 Arm
31 Proximate End of Arm
32 Distal End of Arm
39 Holes Through Arm
40 Clip Along Arm
100 Tag
110 Racing Number
200 Bicycle
210 Frame
211 Top Tube
212 Head Tube
213 Down Tube
214 Seat Tube
215 Chain Stay
216 Top Stay
217 Front Fork
221 Front Wheel
222 Back Wheel
230 Handlebars
240 Seat
245 Seat Post
250 Control Wires on Bicycle
x₁ Forward Direction
x₂ Backward Direction
y₁ Upward Direction
y₂ Downward Direction
p₁ Pivot Point

### Definitions

As utilized herein, including the claims, the phrase “substantially horizontal” means within 10° of horizontal.

As utilized herein, including the claims, the phrase “substantially parallel to ground” means within 10° relative to the plane defined by the ground upon which an item is supported.

### Structure and Operation

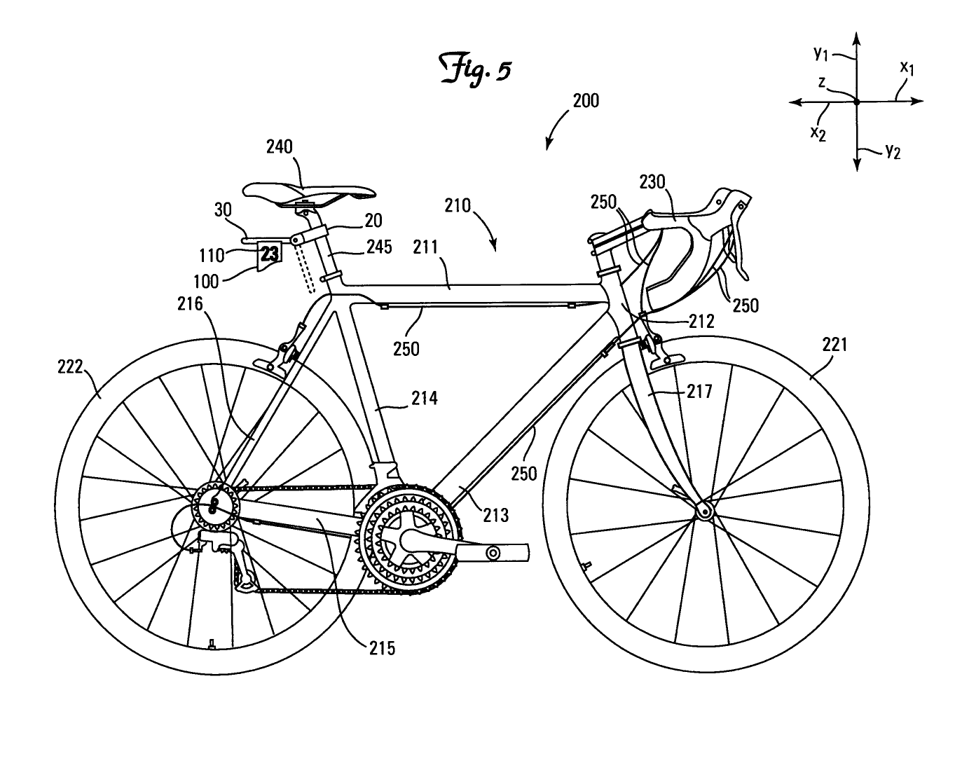

As shown in FIGS. 5 through 9, the invention is a bracket 10 for temporary mounting and displaying a flexible tag 100 bearing a racing number 110 onto a bicycle 200.

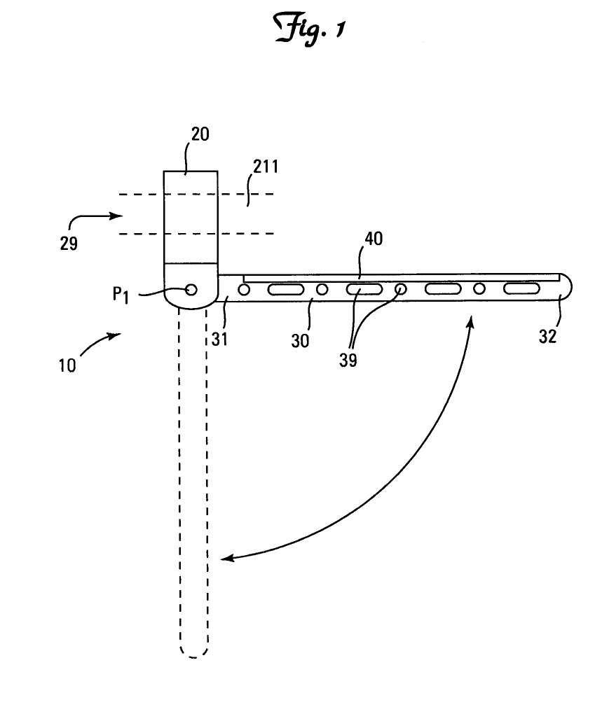

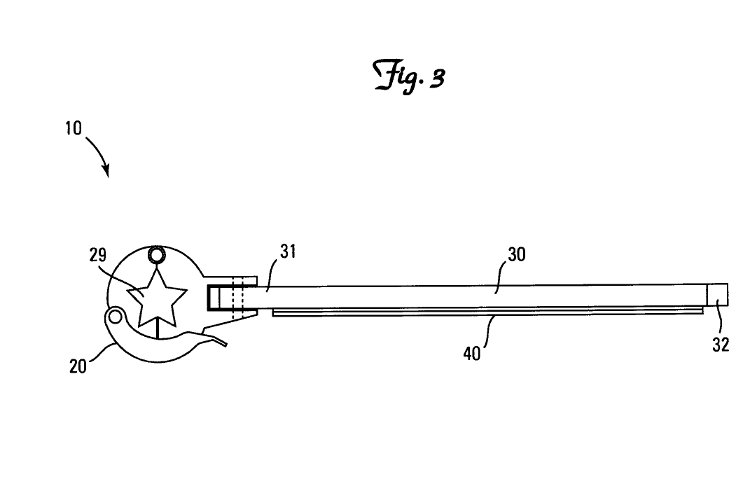

Referring to FIGS. 1 through 4, the bracket 10 includes a fastener 20 for releasably attaching the bracket 10 to the bicycle 200 and an arm 30 pivotably attached to the fastener 20 at a pivot point p₁ for pivoting between a storage position and a display position.

The fastener 20 can be selected from any of the numerous, well known devices and systems capable of releasable attachment to a tube, including specifically but not exclusively T-bolt band clamps, barrel hardware clamps and worm gear clamps such as those available from Clampco Products, Inc. of Wadsworth, Ohio. A preferred fastener 20, depicted in FIGS. 1-4, is an adjustable-diameter, quick-release mechanism of the type shown and described in U.S. Pat. No. 7,044,530, the disclosure of which is hereby incorporated by reference. Another preferred type of fastener 20 is comprised of a longitudinally slit flexible sleeve (not shown) or a U-shaped sleeve (not shown) capable of being secured to any tube or post on a bicycle frame 210 with zip ties (not shown).

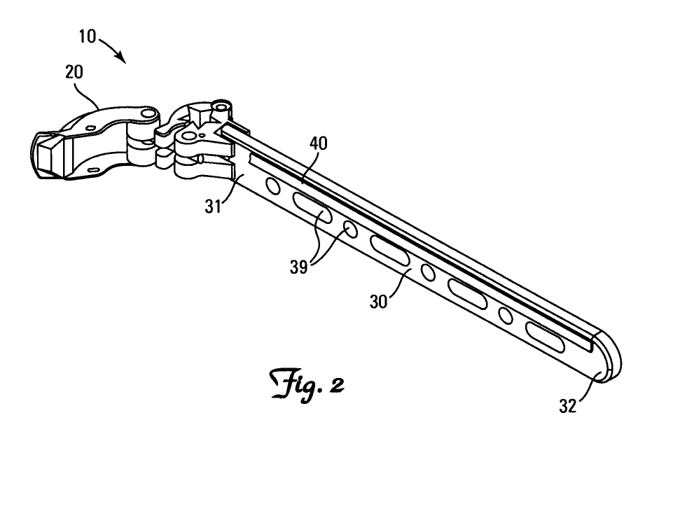

As seen in FIGS. 2 through 4, the bore 29 through the fastener 20 is preferably noncircular (e.g., oval, egg, teardrop, diamond, star, square, rectangular, etc.) so that when the fastener 20 is attached to a bicycle frame 210 at least one open channel is formed along the length of the bore 29 between the inside surface (unnumbered) of the fastener 20 and the bicycle frame 210 so that control wires 250 running along the length of the frame 210 may pass unfettered through the bore 29.

The proximate end 31 of the arm 30 is pivotably attached to the fastener 20 at a pivot point p₁ for pivoting between at least a storage position and a display position. A system, such as a ball detent or similar system (not shown) is preferably provided at the interface between the fastener 20 and the arm 30 so that the arm 30 will resist continued pivoting when placed in the storage and display positions. The distal end 32 of the arm 30 is unrestricted.

It is common practice for cyclists entered in a race to be assigned a race number 110 for that race. The race number 110 is printed onto a bib (not shown) for attachment to the cyclist's clothing (not shown), and a tag 100, typically an adhesive label, for attachment to the cyclist's bicycle 200. Upon completion of the race the race number 110 has no further value and both the bib and tag 100 may be retained as a souvenir or simply discarded.

The tag 100 bearing the racing number 110 may be releasably attached to a bicycle 200 via the bracket 10 by simply sliding an edge of the tag 100 into a clip 40 provided on the arm 30, by passing separate and independent clips (not shown) (e.g., paper clips, carabiners, etc) through holes (not shown) in the tag 100 and holes 39 in the arm 30, or by simply removing the release liner (not shown) from an adhesive tag 100 and adhering the tag 100 to the arm 30.

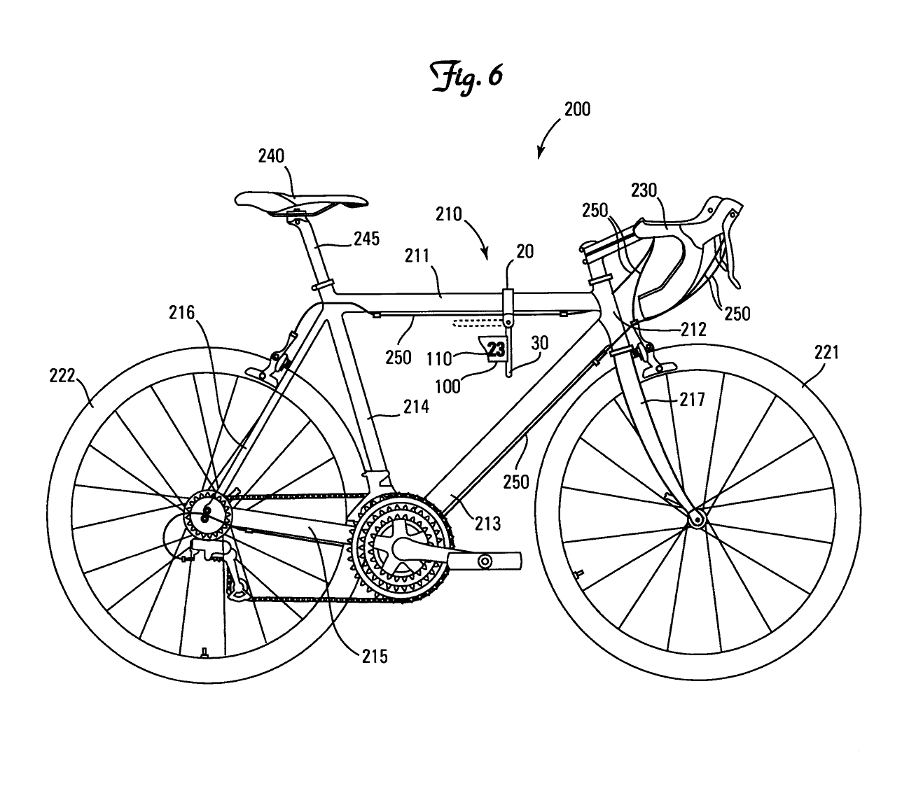

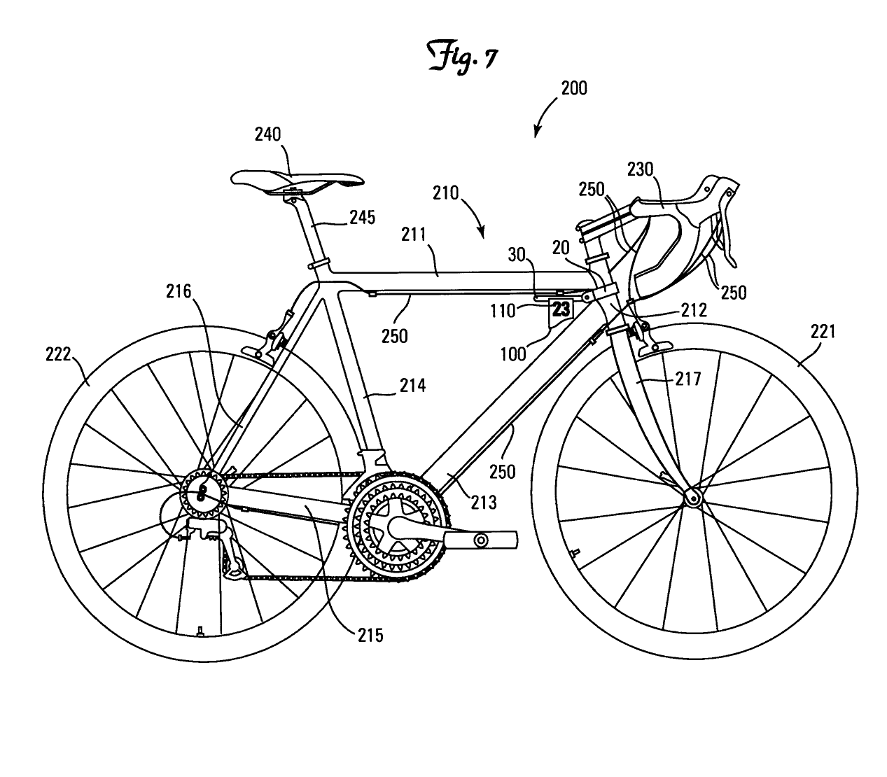

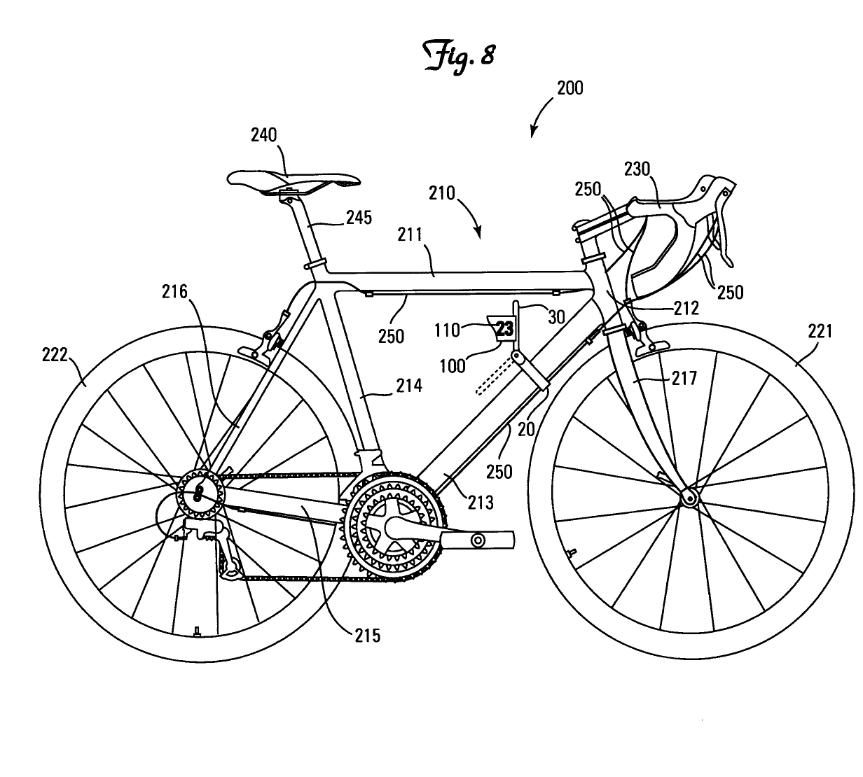

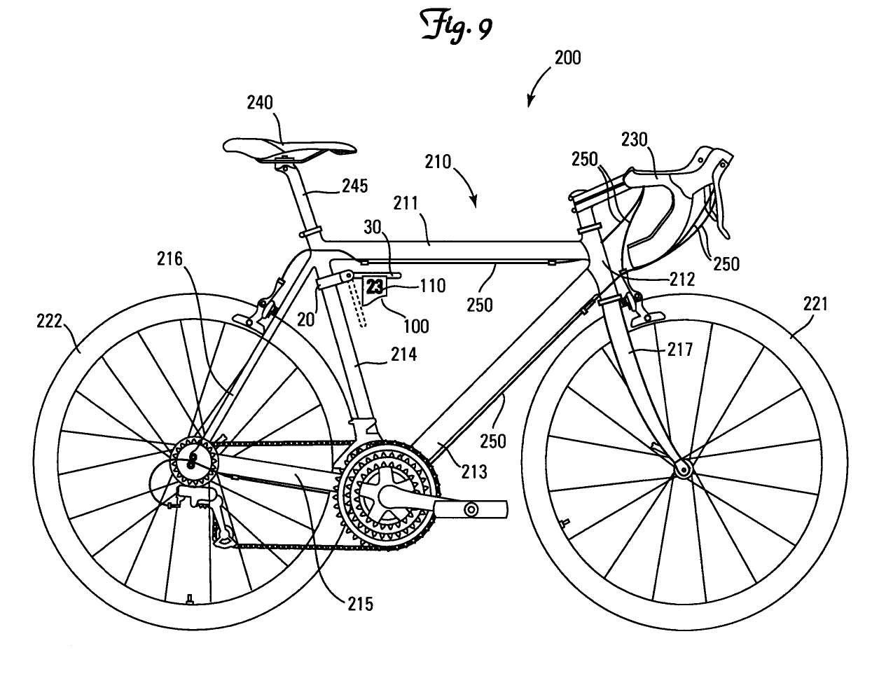

The bracket 10 can be quickly and easily attached, detached and reattached to any tubular part of the bicycle 200, such as the frame 210, handlebars 230 and seat post 245. Particularly suitable locations and configurations for attachment of the bracket 10 to a bicycle 200 include (i) attachment to the seat post 245 below the seat 240 with the arm 30 extending backward x₂ from the seat post 245 (FIG. 5), (ii) attachment to the top tube 211 with the arm 30 extending downward y₂ from the top tube 211 (FIG. 6), (iii) attachment to the head tube 212 with the arm 30 extending backward x₂ from the head tube 212 (FIG. 7), (iv) attachment to the down tube 213 with the arm 30 extending upward y₁ from the down tube 213 (FIG. 8), and (v) attachment to the seat tube 214 with the arm 30 extending forward x₁ from the seat tube 214 (FIG. 9).

The bracket 10 may also be attached to the chain stay 215, top stay 216 or front fork 217, but is not generally preferred due to the possibility of the tag 100 attached to the bracket 10 coming into contact with the front wheel 221 or the back wheel 222. The bracket 10 may also be attached to the handlebars 230, but is not one of the preferred positions as it tends to interfere with the cyclist's grip.

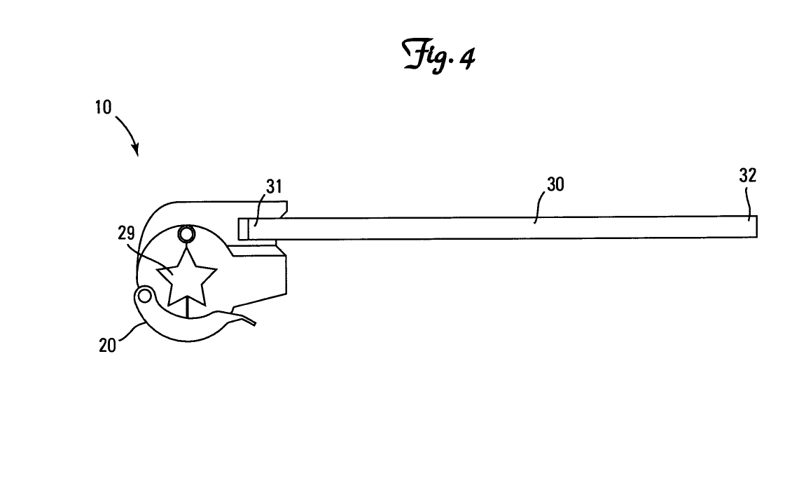

The bracket 10 can retain a tag 100 within the sagital plane of a bicycle 200 (i.e., a plane dividing the bicycle into right and left halves) by employing the embodiment shown in FIG. 1 through 3 wherein the arm 30 extends radially from the center of the bore 29 in the fastener 20. Such positioning of the tag 100 is generally preferred when the tag 100 is positioned within the interior portion of the bicycle frame 210 in order to minimize any contact between the bracket 10 and retained tag 100 and the legs (not shown) of a cyclist (not shown) on the bicycle 100. Alternatively, the bracket 10 can retain a tag 100 outside but parallel to the sagital plane of a bicycle 200 by employing the embodiment shown in FIG. 4 wherein the arm 30 extends tangentially from the bore 29 in the fastener 30. Such positioning of the tag 100 is generally preferred when the tag 100 is positioned near a wheel 221 or 222 in order to minimize any contact between the bracket 10 and retained tag 100 and the wheel 221 or 222. By holding the tag 100 within or parallel to the sagital plane of a bicycle 200 the wind resistance created by the tag 100 can be minimized.

The bracket 10 can be made from substantially any structural material ranging from paperboard, cardboard, wood, plastic, metal, rubber, carbon fiber reinforced plastic, and combinations thereof.

The arm 30 can have any desired length (distance from proximal end 31 to distal end 32), with a length of about 4 inches to 12 inches sufficient to accommodate most racing tags 100 with the addition of modest additional weight to the bicycle 200. The arm 30 could be provided with a telescoping feature (not shown) to further minimize the footprint of the bracket 10 when the arm 30 is in the storage position (fully retracted) and when the arm 30 is in the display position (extended only that distance necessary to accommodate a given racing tag 100).

I claim:

1. A bracket for temporary mounting and displaying of a flexible tag bearing a racing number, comprising:
(a) a fastener configured and arranged for releasable attachment to a bicycle,
(b) an arm having a length and pivotably attached to the fastener for pivoting within a plane parallel to the sagittal plane of a bicycle when the bracket is attached to a bicycle as between a storage position and a display position, and
(c) a plurality of orifices spaced along the length of the arm.

2. A bracket for temporary mounting and displaying of a flexible tag bearing a racing number, comprising:
(a) a fastener configured and arranged for releasable attachment to a bicycle,
(b) an arm having a length and pivotably attached to the fastener for pivoting within a plane parallel to the sagittal plane of a bicycle when the bracket is attached to a bicycle as between a storage position and a display position, and
(c) at least one retention clip on the arm configured and arranged to releasably secure a flexible tag bearing a racing number to the arm.

3. The bracket of claim 1 wherein the fastener is a clamp.

4. The bracket of claim 3 wherein the clamp is a quick-release clamp capable of being repeatedly attached and released by hand.

5. The bracket of claim 2 wherein the fastener is a clamp.

6. The bracket of claim 5 wherein the clamp is a quick-release clamp capable of being repeatedly attached and released by hand.

7. The bracket of claim 1 wherein the arm extends substantially horizontally when the bracket is attached to a bicycle frame, the bicycle is upright, and the arm is in the display position.

8. The bracket of claim 2 wherein the arm extends substantially horizontally when the bracket is attached to a bicycle frame, the bicycle is upright, and the arm is in the display position.

9. The bracket of claim 1 wherein the arm is about 4 to 12 inches long.

10. The bracket of claim 1 wherein the arm pivots at least 45° as between the storage and display positions.

11. The bracket of claim 2 wherein the arm pivots at least 60° as between the storage and display positions.

12. The bracket of claim 2 wherein the arm pivots within the sagittal plane of the bicycle.beof the bicycle frame.
